(19) United States
(12) Patent Application Publication
(10) Pub. No.: US 2025/0274029 A1
(43) Pub. Date: Aug. 28, 2025

(54) SWITCH TEMPERATURE COMPENSATED DC-DC CONVERTER

(71) Applicant: KOREA ELECTRONICS TECHNOLOGY INSTITUTE, Seongnam-si (KR)

(72) Inventors: Jun Hyuk CHOI, Bucheon-si (KR); Jin Hong KIM, Suwon-si (KR); Joon Sung PARK, Seoul (KR); Byong Jo HYON, Anyang-si (KR); Yongsu NOH, Seoul (KR); Sang Min PARK, Bucheon-si (KR); Dongmyoung JOO, Seoul (KR); Daeyeon HWANG, Incheon (KR); Poo Reum JANG, Incheon (KR); Hyoung-Kyu YANG, Seoul (KR)

(21) Appl. No.: 19/001,959

(22) Filed: Dec. 26, 2024

(30) Foreign Application Priority Data
Feb. 22, 2024 (KR) 10-2024-0025715

(51) Int. Cl. H02M 1/00; H02M 3/00; H02M 3/158

(52) U.S. Cl. CPC H02M 1/0058; H02M 3/01; H02M 3/158

(57) ABSTRACT

Proposed is a switch temperature compensated DC-DC converter. The converter may include an input circuit connected to an input terminal and including a main switch. The converter may also include a resonant circuit that is connected to the input circuit and includes an auxiliary switch for zero-voltage switching the main switch. The converter may further include an output circuit connected to the resonant circuit and outputting a voltage to an output terminal. The converter may further include a controller that controls the main switch and the auxiliary switch, in which the controller calculates switch temperature information based on temperature information of at least one measurement target switch among the main switch and the auxiliary switch, and controls on duty of the main switch and the auxiliary switch based on the switch temperature information.

### CROSS-REFERENCE TO RELATED APPLICATIONS

This application claims priority under 35 U.S.C. § 119 to Korean Patent Application No. 10-2024-0025715, filed on Feb. 22, 2024, in the Korean Intellectual Property Office, the disclosure of which is incorporated herein by reference in its entirety.

### BACKGROUND

### Technical Field

The following disclosure relates to a switch temperature compensated DC-DC converter, and more particularly, to a switch temperature compensated DC-DC converter capable of controlling on duty of a main switch and an auxiliary switch to compensate for changes in rise time and fall time that occur when turning on or off due to a change in temperature of the switch.

### Description of Related Technology

Recently, a zero voltage transition-partial resonant converter (ZVT-PRC) has been widely used as a power conversion device mounted on aircraft and electric vehicles. Unlike the converter, a zero voltage transition-partial resonant converter converts power using soft switching, so it may have low energy loss and high power transfer efficiency.

### SUMMARY

One aspect is a switch temperature compensated DC-DC converter that can compensate for an increase in rise time and fall time due to a temperature rise of a switch, maintain a voltage across a main switch in a stable zero voltage state, and convert power by soft switching the main switch.

Another aspect is a switch temperature compensated DC-DC converter that includes: an input circuit that is connected to an input terminal and includes a main switch; a resonant circuit that is connected to the input circuit and includes an auxiliary switch for zero-voltage switching the main switch; an output circuit that is connected to the resonant circuit and outputs a voltage to an output terminal; and a controller that controls the main switch and the auxiliary switch, in which wherein the controller calculates switch temperature information based on temperature information of at least one measurement target switch among the main switch and the auxiliary switch, and controls on duty of the main switch and the auxiliary switch based on the switch temperature information.

When the switch temperature information exceeds a predetermined reference value, the controller may control the auxiliary switch so that the on duty of the auxiliary switch increases, and control the main switch so that the on duty of the main switch is delayed.

The controller may include a first lookup table which is a lookup table storing an on-duty increase amount of the auxiliary switch according to the switch temperature information, and control the auxiliary switch so that the on duty of the auxiliary switch increases by adding the on-duty increase amount of the first lookup table to the on duty of the auxiliary switch.

The controller may include a second lookup table which is a lookup table storing a delay time of the main switch according to the switch temperature information, and control the main switch so that the on duty of the main switch is delayed by the delay time of the second lookup table.

The input circuit may include a first inductor having one terminal connected to a positive electrode of the input terminal and the other terminal connected to one terminal of the main switch, and the other terminal of the main switch may be connected to a negative electrode of the input terminal.

The resonant circuit may include: a resonant capacitor connected in parallel with the main switch; a resonant inductor having one terminal connected to the resonant capacitor; and an auxiliary diode having an anode connected to the other terminal of the resonant inductor and a cathode connected to the output circuit, and one terminal of the auxiliary switch may be connected to the other terminal of the resonant inductor, and the other terminal of the auxiliary switch may be connected to the other terminal of the resonant capacitor.

The output circuit may include: a main diode having an anode connected to the other terminal of the resonant inductor and a cathode connected to the cathode of the auxiliary diode; and a DC capacitor having one terminal connected to the cathode of the main diode and the other terminal connected to the negative electrode of the output terminal.

### BRIEF DESCRIPTION OF THE DRAWINGS

FIG. 1 is a circuit diagram of a DC-DC converter.

FIG. 2 is a graph of voltage of components included in the DC-DC converter.

FIG. 3 is a timing diagram illustrating a delay time due to a temperature rise of a power semiconductor.

FIG. 4 is a timing diagram illustrating a case where hard switching occurs due to the temperature rise of the switch in the DC-DC converter.

FIG. 5 is a circuit diagram of a switch temperature compensated DC-DC converter according to an embodiment of the present disclosure.

FIG. 6 is a graph of voltages of components included in a switch temperature compensated DC-DC converter according to an embodiment of the present disclosure when switch temperature information exceeds a predetermined reference value.

### DETAILED DESCRIPTION

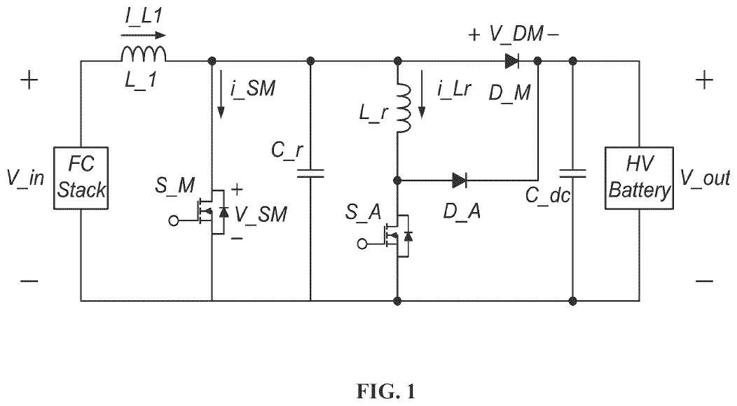

FIG. 1 illustrates a DC-DC converter. As illustrated in FIG. 1, the DC-DC converter boosts an input voltage and transmits the boosted input voltage to an output terminal, and includes a main switch SM and an auxiliary switch SA, respectively. Here, the main switch and the auxiliary switch are power semiconductors.

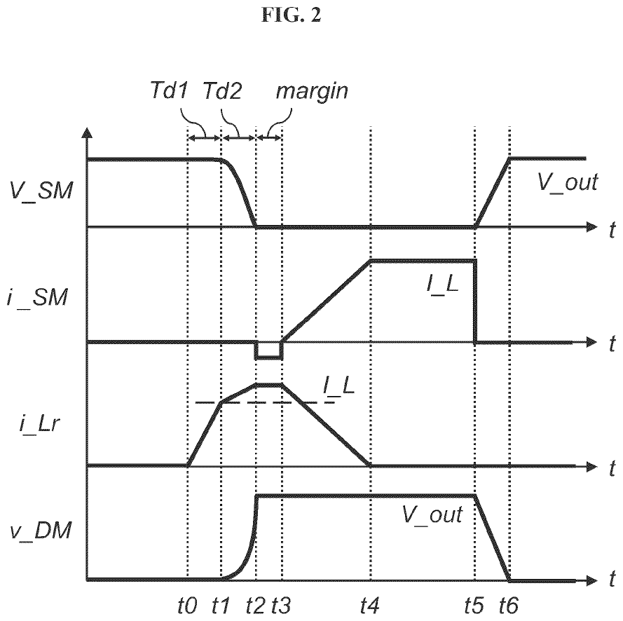

FIG. 2 is a graph of voltages of components included in the DC-DC converter. Referring to FIG. 2, before a turn-on control signal is applied to a gate of the main switch for soft switching, a voltage VSM across the main switch should be in a zero voltage state. The auxiliary switch is turned on in Td1, Td2, and a freewheeling margin of FIG. 2 to help the voltage across the main switch be in the zero voltage state. Here, when the zero voltage state is reached, there is a freewheeling margin in which a freewheeling current flows in a resonant circuit. The freewheeling margin should be minimized so that the energy loss occurring in the converter is reduced. Therefore, the auxiliary switch should be turned off quickly after reaching zero voltage to have a predetermined freewheeling margin.

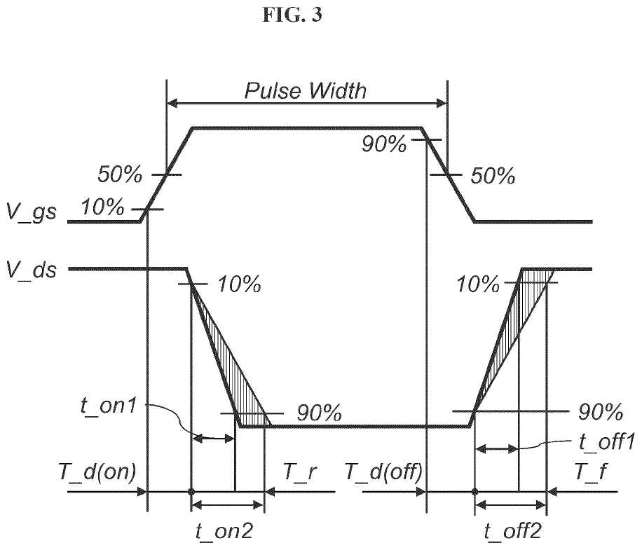

FIG. 3 is a timing diagram illustrating a delay time due to a temperature rise of a power semiconductor. As a PWM signal is applied to a gate of a power semiconductor, when the time taken for a voltage Vds between a drain and a source to reach from 10% to 90% at turn-on is a rise time ton, the time taken for the voltage between the drain and the source to reach from 90% to 10% at turn-off is a fall time toff, as illustrated in FIG. 3, as the temperature of the power semiconductor rises, the rise time at turn-on of the switch increases from the existing ton1 to ton2, and the fall time at turn-off increases from toff1 to toff2. In other words, the time taken for turn-on or turn-off increases more after the temperature rises than before the temperature rises.

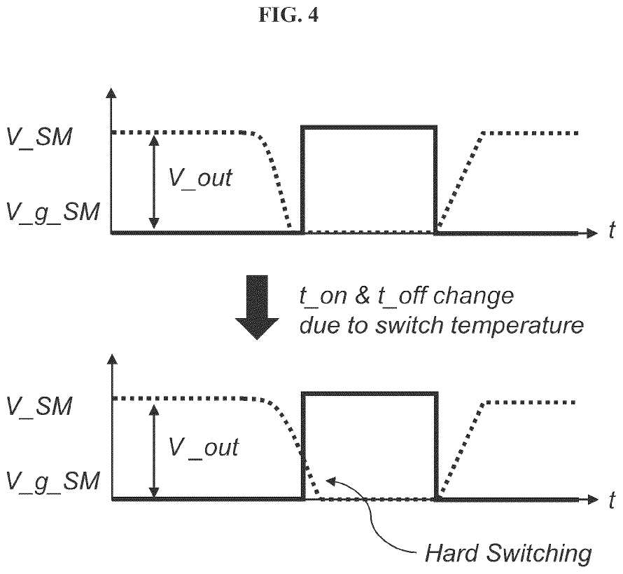

FIG. 4 is a timing diagram illustrating a case where hard switching occurs due to the temperature rise of the switch in the DC-DC converter.

Soft switching is possible only when the voltage VSM across the main switch is in the zero voltage state before the PWM signal is applied to the gate of the main switch. However, when the temperature of the auxiliary switch rises, the rise time and fall time at turn-on or turn-off become longer, and the time to reach the zero voltage state also becomes longer. Accordingly, as illustrated in FIG. 4, the main switch is turned on before the voltage VSM across the main switch becomes the zero voltage state, so the energy loss due to the hard switching occurs as the main switch is conducted.

That is, the above-described DC-DC converter has a problem in that the rise time and fall time increase due to the temperature rise of the main switch and the auxiliary switch and thus the hard switching occurs.

The above-described objects, features, and advantages of the present disclosure will become more obvious from the following detailed description provided in relation to the accompanying drawings. The following specific structural or functional descriptions are only exemplified for the purpose of explaining the embodiments according to the concept of the present disclosure, and the embodiments according to the concept of the present disclosure may be implemented in various forms and should not be construed as limited to the embodiments described herein or in the application. Since embodiments of the concept of the present disclosure may be variously modified and may have several forms, specific embodiments will be illustrated in the accompanying drawings and will be described in detail in the present specification or application. However, it is to be understood that the present disclosure is not limited to specific embodiments, but includes all modifications, equivalents, and substitutions falling in the spirit and the scope of the present disclosure. Terms such as first, second, or the like, may be used to describe various components, but these components are not to be construed as being limited to these terms. The terms are used only to distinguish one component from another component. For example, a first component may be named a second component and the second component may also be named the first component, without departing from the scope of the present disclosure. It is to be understood that when one component is referred to as being “connected to” or “coupled to” another component, it may be connected directly to or coupled directly to another component or be connected to or coupled to another component with the other component interposed therebetween. On the other hand, it is to be understood that when one component is referred to as being “connected directly to” or “coupled directly to” another component, it may be connected to or coupled to another component without the other component interposed therebetween. Other expressions for describing the relationship between components, such as between and immediately between or adjacent to and directly adjacent to, etc., should be interpreted similarly. Terms used in the present specification are used only in order to describe specific embodiments rather than limiting the present disclosure. Singular forms include plural forms unless the context clearly indicates otherwise. It is to be understood that terms “include,” “have,” or the like, used in the present specification specify the presence of features, numerals, steps, operations, components, parts, or a combination thereof described in the present specification, but do not preclude the presence or addition of one or more other features, numerals, steps, operations, components, parts, or a combination thereof. Unless indicated otherwise, it is to be understood that all the terms used in the specification including technical and scientific terms have the same meaning as those that are generally understood by those who skilled in the art. Terms generally used and defined in a dictionary are to be interpreted as the same meanings with meanings within the context of the related art, and are not to be interpreted as ideal or excessively formal meanings unless clearly indicated in the present specification. Hereinafter, exemplary embodiments of the present disclosure will be described in detail with reference to the accompanying drawings. The same reference numerals in each drawing denote the same components.

Hereinafter, a switch temperature compensated DC-DC converter 1 according to an embodiment of the present disclosure will be described in detail with reference to the attached drawings.

As illustrated in FIG. 3 in this specification, when a PWM signal is applied to a gate in a power semiconductor, the time taken for a voltage between a drain and a source to reach from 10% to 90% at turn-on is defined as a rise time, and the time taken for the voltage between the drain and the source to reach from 90% to 10% at turn-off is defined as a fall time.

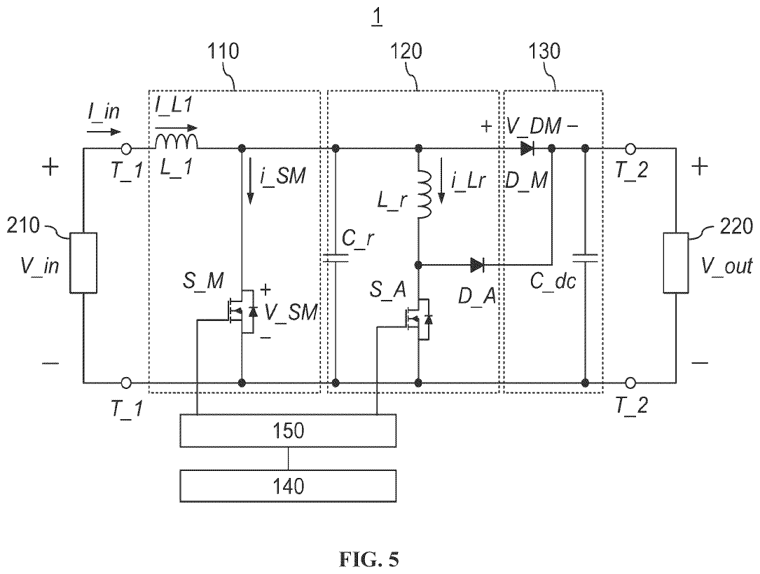

FIG. 5 is a circuit diagram of the switch temperature compensated DC-DC converter according to an embodiment of the present disclosure.

The switch temperature compensated DC-DC converter 1 according to an embodiment of the present disclosure basically has characteristics of a boost converter. A voltage of a first power supply 210 applied to an input terminal T1 through a first inductor L1 and a main switch SM of an input circuit 110 and a main diode DM and a DC capacitor Cdc of an output circuit 130 is boosted and output to a second power supply 220 of an output terminal. The switch temperature compensated DC-DC converter 1 according to the present disclosure includes a resonant circuit 120 to assist soft switching of the main switch SM.

That is, the switch temperature compensated DC-DC converter 1 according to an embodiment of the present disclosure applies a partial resonant topology that enables zero voltage switching by generating resonance through the resonant circuit 120 for a certain period of time for soft switching of the main switch SM.

Basically, the switch temperature compensated DC-DC converter 1 according to an embodiment of the present disclosure operates on the same principle as the graph of voltages of components included in the DC-DC converter of FIG. 2, but the time of Td1, Td2, and freewheeling margin of the switch temperature compensated DC-DC converter 1 according to an embodiment of the present disclosure and the time at which a voltage VSM across the main switch becomes zero voltage may have different values from those of the DC-DC converter of FIG. 2. However, even in this situation, a controller 140 of the switch temperature compensated DC-DC converter 1 according to an embodiment of the present disclosure controls an auxiliary switch SA and the main switch SM so that the main switch SM is turned on after the auxiliary switch SA is turned off.

The first power supply 210 and the second power supply 220 are energy sources that may provide or receive power. For example, the first power supply and second power supply may be a DC power supply such as a DC power supply, a power conversion device, and a battery including a fuel cell, a lithium ion battery, etc.

The switch temperature compensated DC-DC converter 1 according to the present disclosure includes the input circuit 110, the resonant circuit 120, the output circuit 130, and the controller 140.

The input circuit 110 is connected to the input terminal T1 and includes the main switch SM. Specifically, the input circuit 110 is connected to the input terminal T1 and includes the first inductor L1 and the main switch SM.

The input circuit 110 is connected to the first power supply 210 through the input terminal T1. The first power supply 210 may be a device that outputs power having a DC voltage, and may be, for example, a secondary battery such as a fuel cell, a lithium ion battery, etc.

The first inductor L1 has one terminal connected to a positive electrode of the input terminal T1 and the other terminal connected to one terminal of the main switch SM.

The main switch SM has one terminal connected to the first inductor L1 and the other terminal connected to a negative electrode of the input terminal T1. The main switch SM may include a body diode as a power semiconductor. The main switch may be composed of a power semiconductor element such as SiC or GaN.

The resonant circuit 120 is connected to the input circuit 110 and includes the auxiliary switch SA for performing zero-voltage switching of the main switch SM. Specifically, the resonant circuit 120 includes a resonant capacitor Cr, a resonant inductor Lr, the auxiliary switch SA, and an auxiliary diode DA.

The resonant capacitor Cr is connected in parallel with the main switch SM. Specifically, one terminal of the resonant capacitor Cr is connected to one terminal of the main switch SM, and the other terminal is connected to the other terminal of the main switch SM.

The resonant inductor Lr has one terminal connected to the resonant capacitor Cr, and the other terminal is connected to one terminal of the auxiliary switch SA.

A capacitance of the resonant capacitor Cr and an inductance of the resonant inductor Lr may have values that may cause resonance with each other.

The auxiliary switch SA has one terminal connected to the other terminal of the resonant inductor Lr, and the other terminal is connected to the other terminal of the resonant capacitor Cr. Like the main switch SM, the auxiliary switch SA may include the body diode as the power semiconductor.

The auxiliary diode DA has an anode connected to the other terminal of the resonant inductor Lr and a cathode connected to the output circuit 130. Specifically, the anode of the auxiliary diode DA is connected between the other terminal of the resonant inductor Lr and one terminal of the auxiliary switch SA, and the cathode is connected to a cathode of the main diode DM.

That is, depending on whether the auxiliary switch SA is turned on or off, the resonant capacitor Cr and the resonant inductor Lr resonate to enable the main switch SM of the input circuit 110 to be switched at zero voltage.

The output circuit 130 is connected to the resonant circuit 120 and outputs the converted voltage to an output terminal T2. Specifically, the output circuit 130 includes the main diode DM and the DC capacitor Cdc.

The main diode DM has an anode connected to the other terminal of the resonant inductor Lr and a cathode connected to the cathode of the auxiliary diode DA.

The DC capacitor Cdc has one terminal connected to the cathode of the main diode DM and the other terminal connected to a negative electrode of the output terminal T2. Specifically, the DC capacitor Cdc smoothes the voltage output from the main diode DM.

The controller 140 controls the main switch SM and the auxiliary switch SA. The controller 140 controls the main switch SM and the auxiliary switch SA so that the DC voltage input from the switch temperature compensated DC-DC converter 1 to the input terminal T1 of the switch temperature compensated DC-DC converter 1 is boosted and the boosted DC voltage is output to the output terminal. In the power conversion process, the controller 140 controls the main switch SM according to a duty control method of a general boost converter. At the same time, the controller 140 turns on the auxiliary switch SA at Td1, Td2, and freewheeling margin of FIG. 2 so that the main switch SM is switched to a zero voltage, thereby causing the resonant circuit 120 to resonate.

In the switch temperature compensated DC-DC converter 1 according to an embodiment of the present disclosure, the controller 140 calculates switch temperature information based on temperature information of at least one measurement target switch among the main switch SM and the auxiliary switch SA, and controls the on duty of the main switch SM and the auxiliary switch SA based on the switch temperature information.

A method for calculating switch temperature information will be described.

The controller 140 acquires the temperature information of the main switch SM and the auxiliary switch SA. Specifically, the controller 140 may calculate the information on the temperature of the main switch SM and the auxiliary switch SA by receiving the temperature information from a converter temperature measuring device for measuring the temperature of the converter or a switch temperature measuring device for measuring the temperature of the switches included in the converter. The converter temperature measuring device or the switch temperature measuring device may be provided separately from the switch temperature compensated DC-DC converter 1 according to the present disclosure, and may be included in the controller 140. For example, the switch temperature measuring device may be an NTC thermistor element.

The controller 140 calculates the switch temperature information based on the temperature information of at least one of the measurement target switches among the main switch SM and the auxiliary switch SA. Specifically, the measurement target switch may be either one of the main switch SM and the auxiliary switch SA, and the switch temperature information may be calculated based on at least one of the temperature information of the main switch SM and the temperature information of the auxiliary switch SA. For example, when the measurement target switch is the main switch SM, the switch temperature information may be the temperature information of the main switch SM. When the measurement target switch is the auxiliary switch SA, the switch temperature information may be the temperature information of the auxiliary switch SA. When the measurement target switches are the main switch SM and the auxiliary switch SA, the switch temperature information may include the temperature information of the main switch SM and the temperature information of the auxiliary switch SA. As another example, the controller 140 may calculate an arithmetic mean or a geometric mean of the temperature of the main switch SM and the temperature of the auxiliary switch SA to derive the switch temperature information.

A method for controlling on duty of the main switch SM and the auxiliary switch SA based on the switch temperature information is described.

The controller 140 controls the auxiliary switch SA so that the on duty of the auxiliary switch SA increases when the switch temperature information exceeds a predetermined reference value, and controls the main switch SM so that the on duty of the main switch SM is delayed.

The controller 140 determines whether the switch temperature information exceeds the predetermined reference value. Specifically, the predetermined reference value means the switch temperature information in an environment where the rise time and fall time of the switch are delayed as the temperature of the switch increases, thereby affecting the zero-voltage switching of the main switch SM. The predetermined reference value may be a value determined in advance through a data sheet describing specifications of the auxiliary switch SA or the main switch SM or a double pulse test (DPT) that applies two pulses to the auxiliary switch SA or the main switch SM and measures the switching time accordingly, or may be a value arbitrarily set by a user or the like. The controller 140 may store the predetermined reference value in a storage medium (not illustrated). The controller 140 may calculate the switch temperature information in real time or at a predetermined time interval, and compare the calculated switch temperature information with the predetermined reference value.

The predetermined reference value may have different values depending on the type of the switch to be measured. For example, the predetermined reference value may have a first reference value when the switch to be measured is the main switch SM, and a second reference value when the switch to be measured is the auxiliary switch SA. The controller 140 may change the predetermined reference value depending on the switch to be measured while storing and maintaining the first and second reference values in the storage medium (not illustrated).

When the switch temperature information is lower than or equal to the predetermined reference value, the controller 140 controls the switch temperature compensated DC-DC converter 1 using a control method of a DC-DC converter.

However, as described above, when the switch temperature information exceeds the predetermined reference value, the controller 140 may control the auxiliary switch SA so that the on duty of the auxiliary switch SA increases, and control the main switch SM so that the on duty of the main switch SM is delayed.

To this end, the controller 140 of the present disclosure may include a first lookup table, which is a lookup table storing the on-duty increase amount of the auxiliary switch SA according to the switch temperature information. Specifically, the first lookup table stores the on-duty increase amount of the auxiliary switch SA according to the switch temperature information. In this way, the on-duty increase amount the auxiliary switch SA according to the switch temperature information may be a value calculated through a prior experiment, and the first lookup table may store the on-duty increase amount of the auxiliary switch SA in a one-to-one correspondence according to the switch temperature information. For example, when the switch temperature information increases, the on-duty increase amount of the auxiliary switch SA may have an increasing value.

The controller 140 of the present disclosure may include a second lookup table, which is a lookup table storing a delay time of the main switch SM according to the change amount of the switch temperature information Specifically, the second lookup table stores the delay time of the main switch SM according to the switch temperature information. In this way, the delay time of the main switch SM according to the switch temperature information may be a value calculated through a prior experiment, and the delay time of the main switch SM may be stored in the second lookup table in a one-to-one correspondence according to the switch temperature information. For example, when the switch temperature information increases, the delay time of the main switch SM may have an increasing value.

For example, the on-duty increase amount of the auxiliary switch SA of the first lookup table and the delay time of the main switch SM of the second lookup table may be values calculated through the DPT, which is an experiment that applies two pulses to the auxiliary switch SA or the main switch SM and measures the switching time accordingly.

The first lookup table and the second lookup table may be included in the storage medium (not illustrated) included in the controller 140. The storage medium (not illustrated) may store an algorithm or program for controlling the main switch SM and the auxiliary switch SA of the present disclosure, and may be formed of a nonvolatile memory or a volatile memory.

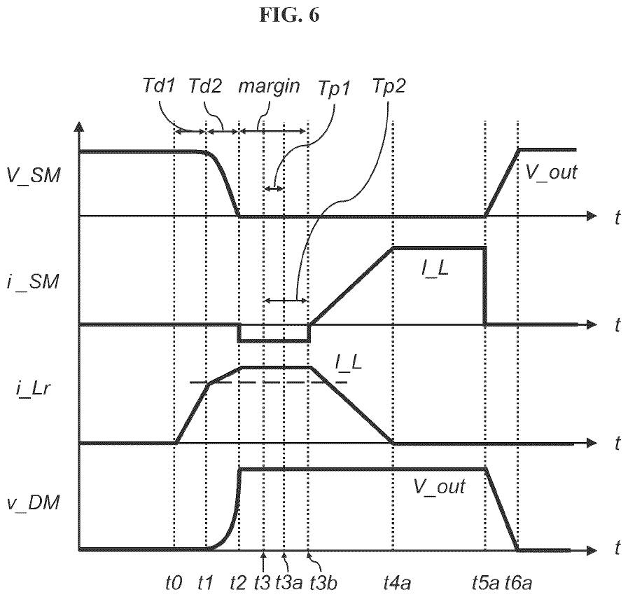

FIG. 6 is a graph of voltages of components included in the switch temperature compensated DC-DC converter 1 according to an embodiment of the present disclosure when switch temperature information exceeds a predetermined reference value.

The controller 140 controls the auxiliary switch SA so that the on duty of the auxiliary switch SA increases by adding the on-duty increase amount of the first lookup table to the on duty of the auxiliary switch SA. Specifically, the controller 140 calculates the on-duty increase amount according to the switch temperature information from the first lookup table. The controller 140 adds the on-duty increase amount calculated from the first lookup table to the on duty of the auxiliary switch SA. The controller 140 controls the auxiliary switch SA with the added on duty.

Referring to FIGS. 2 and 6, when the on duty of the auxiliary switch SA is t0 to t3 as in FIG. 2, an on-duty increase amount Tp1 may be added to the on duty of the auxiliary switch SA in order to compensate for the delay in the rise time and fall time of the switch as the switch temperature information exceeds the predetermined reference value. Therefore, the on duty of the auxiliary switch SA is equal to a time value of t0 to t3a section, and the auxiliary switch SA is turned on by the controller 140 during the time from t0 to t3a. In this way, the freewheeling margin increases, thereby helping the main switch SM to perform the soft switching stably.

However, since the energy loss of the converter also increases when the freewheeling margin increases, it is preferable to add the on-duty increase amount of the auxiliary switch SA to an extent that may compensate for the delay in the rise time and fall time of the switch.

The controller 140 controls the main switch SM so that the on duty of the main switch SM is delayed by the delay time of the second lookup table. Specifically, the controller 140 calculates the delay time according to the switch temperature information in the second lookup table. The controller 140 controls the main switch SM so that the on duty of the main switch SM is turned on with a delay equal to the delay time calculated from the second lookup table. The difference from the auxiliary switch SA is that in the case of the main switch SM, there is a difference in the point in time at which the on duty is turned on, but the on duty value itself does not change.

Referring to FIGS. 2 and 6, as illustrated in FIG. 2, the main switch SM is turned on at t3, which is the point in time at which the auxiliary switch SA is turned off, and a current iSM of the main switch SM increases. However, in the case of FIG. 6, as the switch temperature information exceeds the predetermined reference value, in order to compensate for the delay in the rise time and fall time of the switch, the controller 140 controls the main switch SM so that the on duty of the main switch SM is delayed by a delay time Tp2 from the turn-on time point t3 of the main switch SM and is turned on. Therefore, the on duty of the main switch SM is equal to a time value of t3b to t5a section, and the main switch SM is controlled to be turned on by the controller 140 during the time t3b to t5a. In this way, the freewheeling margin increases, so that the main switch SM may be soft-switched stably.

However, since the energy loss of the converter also increases when the freewheeling margin increases, it is preferable that the on duty of the main switch SM is delayed to an extent that may compensate for the delay in the rise time and fall time of the switch.

In the switch temperature compensated DC-DC converter 1 according to an embodiment of the present disclosure, the delay time has a value equal to or greater than the on-duty increase amount. Specifically, as illustrated in FIG. 6, the delay time Tp1 of the main switch SM may have a value equal to or greater than the on-duty increase amount Tp2 of the auxiliary switch SA. In order to perform the soft switching of the main switch SM, the main switch SM is generally turned on at the same time as the auxiliary switch SA is turned off. However, in the present disclosure, in order to ensure the stable soft switching operation of the main switch SM, the controller 140 may control the auxiliary switch SA and the main switch SM so that the main switch SM is turned on after the predetermined delay by turning off the auxiliary switch SA.

The switch temperature compensated DC-DC converter 1 according to an embodiment of the present disclosure may further include a driver 150 that drives the main switch SM and the auxiliary switch SA according to the control of the controller 140. Specifically, the driver 150 may apply a PWM signal to the gate of the main switch SM and the gate of the auxiliary switch SA according to the control of the controller 140.

By controlling the turn-on and turn-off timing of the variable target switch of either the main switch SM or the auxiliary switch SA, it is possible to prevent the hard switching that may occur in the DC-DC converter according to the change in temperature of the switch, thereby preventing the energy loss that may occur during the hard switching.

As a result, since the effect of the present disclosure can be achieved by only changing the control method of the variable target switch without adding the separate circuits, it is possible to simplify the circuit configuration and reduce the cost required for the circuit configuration.

According to the switch temperature compensated DC-DC converter according to the present disclosure as described above, by controlling the turn-on and turn-off timing of the variable target switch of either the main switch or the auxiliary switch, it is possible to prevent the hard switching that may occur in the DC-DC converter due to the change in temperature of the switch, thereby preventing the energy loss that may occur during the hard switching.

As a result, since the effect of the present disclosure can be achieved by only changing the control method of the variable target switch without adding the separate circuits, it is possible to simplify the circuit configuration and reduce the cost taken for the circuit configuration.

The present disclosure should not be construed to being limited to the embodiment described above. The present disclosure may be applied to various fields and may be variously modified by those skilled in the art without departing from the scope of the present disclosure claimed in the claims. Therefore, it is obvious to those skilled in the art that these alterations and modifications fall in the scope of the present disclosure.

What is claimed is:

1. A switch temperature compensated DC-DC converter, comprising:
an input circuit connected to an input terminal and including a main switch;
a resonant circuit connected to the input circuit and including an auxiliary switch for zero-voltage switching the main switch;
an output circuit connected to the resonant circuit and configured to output a voltage to an output terminal; and
a controller configured to control the main switch and the auxiliary switch,
the controller further configured to:
calculate switch temperature information based on temperature information of at least one measurement target switch among the main switch and the auxiliary switch, and
control on duty of the main switch and the auxiliary switch based on the switch temperature information.

2. The switch temperature compensated DC-DC converter of claim 1, wherein, in response to the switch temperature information exceeding a predetermined reference value,
the controller is configured to:
control the auxiliary switch so that the on duty of the auxiliary switch increases, and
control the main switch so that the on duty of the main switch is delayed.

3. The switch temperature compensated DC-DC converter of claim 2, wherein the controller includes a first lookup table configured to store an on-duty increase amount of the auxiliary switch according to the switch temperature information, and
wherein the controller is configured to control the auxiliary switch so that the on duty of the auxiliary switch increases by adding the on-duty increase amount of the first lookup table to the on duty of the auxiliary switch.

4. The switch temperature compensated DC-DC converter of claim 2, wherein the controller includes a second lookup table configured to store a delay time of the main switch according to the switch temperature information, and
wherein the controller is configured to control the main switch so that the on duty of the main switch is delayed by the delay time of the second lookup table.

5. The switch temperature compensated DC-DC converter of claim 1, wherein the input circuit includes a first inductor comprising a first terminal connected to a positive electrode of the input terminal and a second terminal connected to a first terminal of the main switch, and
wherein a second terminal of the main switch is connected to a negative electrode of the input terminal.

6. The switch temperature compensated DC-DC converter of claim 1, wherein the resonant circuit includes:
a resonant capacitor connected in parallel with the main switch;
a resonant inductor comprising a first terminal connected to the resonant capacitor; and
an auxiliary diode comprising an anode connected to a second terminal of the resonant inductor and a cathode connected to the output circuit, and
wherein a first terminal of the auxiliary switch is connected to the second terminal of the resonant inductor and a second terminal of the auxiliary switch is connected to the second terminal of the resonant capacitor.

7. The switch temperature compensated DC-DC converter of claim 6, wherein the output circuit includes:
a main diode comprising an anode connected to the second terminal of the resonant inductor and a cathode connected to the cathode of the auxiliary diode; and
a DC capacitor comprising a first terminal connected to the cathode of the main diode and a second terminal connected to a negative electrode of the output terminal.
